(19) United States
(12) Patent Application Publication
(10) Pub. No.: US 2017/0131775 A1
(43) Pub. Date: May 11, 2017

(54) SYSTEM AND METHOD OF HAPTIC FEEDBACK BY REFERRAL OF SENSATION

(71) Applicant: CastAR, Inc., Palo Alto, CA (US)

(72) Inventor: Ken Clements, Los Gatos, CA (US)

(21) Appl. No.: 15/347,590

(22) Filed: Nov. 9, 2016

Related U.S. Application Data
(60) Provisional application No. 62/253,253, filed on Nov. 10, 2015.

(51) Int. Cl. G06F 3/01; A63F 13/285; G06T 19/00

(52) U.S. Cl. CPC G06F 3/016; G06F 3/017; G06T 19/006; A63F 13/285

(57) ABSTRACT

A system and method is presented to increase the sense of immersion in virtual and augmented reality systems by means of touch stimulation (haptic output) that is referred from the point of actual stimulation to the perceived point or points of contact with virtual objects and/or surfaces.

### CROSS REFERENCE TO RELATED APPLICATIONS

The present application claims the benefit of U.S. Provisional Application No. 62/253,253, the contents of which are hereby incorporated by reference.

### FIELD OF THE INVENTION

An embodiment of the present invention is generally related to haptic feedback in the context of virtual reality systems and augmented reality systems.

### BACKGROUND OF THE INVENTION

Many virtual and augmented reality systems exist in which contact with a virtual object, as seen by a user, is accompanied with a sense of touch (haptic output) so as to give a better impression of immersion. Such systems usually include “gloves” or “suits” or other contact means that provide a stimulation or force feedback at the user body location that is virtually contacting said virtual object. Providing said stimulation point is difficult in situations where the user cannot, or does not wish to, wear any such apparatus.

As illustrated FIG. 1 shows a haptic interface as is common in the prior art. The user 101 is wearing a head mounted virtual reality display unit 102 and a haptic feedback glove 103 (connecting wires not shown). When the user reaches out with said glove, its position is tracked against the corresponding position in the virtual space and a sensory feedback sensation is generated in said glove when it is “contacting” said virtual object or surface 104.

However, a haptic feedback glove has many potential drawbacks. For example, feedback gloves can be hot and uncomfortable during extended use. Moreover, some users may find using the gloves uncomfortable during extend use due to health reasons, such as users with arthritis. High performance haptic feedback gloves can be more expensive than desired in some applications.

Embodiments of the present invention were developed in view of some of these and other issues.

### BRIEF DESCRIPTION OF THE DRAWINGS

The foregoing summary, as well as the following detailed description of illustrative implementations, is better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 illustrates a haptic feedback interface in accordance with the prior art.

FIG. 2 illustrates a referred haptic interface with haptic stimulation in a head mounted display being referred to a user's hand in accordance with an embodiment.

FIG. 3 illustrates a remote referred haptic interface with haptic stimulation in an arm being referred to a user's hand in accordance with an embodiment.

FIGS. 4A, 4B, and 4C illustrate a referred haptic interface device based on stimulation of an ear canal being referred to a different body location in accordance with an embodiment

FIGS. 5A. 5B. and 5C illustrate aspects of interactions of virtual objects and finger positions for a haptic training method of the flow chart of FIG. 5D of a first referred haptic training method in accordance with an embodiment.

FIGS. 6A, 6B, and 6C illustrates aspects of interactions of virtual objects and finger pistons for a haptic training method of the flow chart of FIG. 6D of a second referred haptic training method in accordance with an embodiment.

FIG. 7 is a flow chart of a referred haptic training game method in accordance with an embodiment.

FIG. 8 illustrates aspects of a variable response training method in accordance with an embodiment.

FIGS. 9A and 9B illustrate a general HMD and referred haptic device system of use and training system.

FIGS. 10A and 10B illustrate general methods of use and training methods for the system of FIGS. 9A and 9B.

FIGS. 11A and 11B illustrate aspects of operating a haptic device to obtain a plurality of different referred haptic stimulation patterns.

### DETAILED DESCRIPTION

Embodiments of the present invention provide haptic feedback by referral of sensation from one body location to another. That is, stimulation/sensation is provided in a first body location and the user's brain, through subliminal or formal training, learns to associate that with a second location. The training process utilizes the plasticity of human proprioception, which is a form of neural plasticity.

The referred haptic feedback can be coordinated with virtual images generated by a head mounted display (HMD), such as virtual reality (VR) or augmented reality (AR) HMD. In one embodiment, haptic feedback is provided by generating stimulation/sensation in a region, other than the fingers of a human hand, and through training users learn to associate the haptic feedback with their fingers. Other examples include using referral of sensation to provide haptic feedback for feet, legs, arms, etc.

Embodiments of the present invention include systems having a head mounted display and a separate haptic device. Alternatively, the haptic device may be integrated into the head mounted display. For example, in one embodiment the plasticity of human proprioception and other somatosensory pathways permits the redirection the physical sensation of touch in the area of a head mounted display (for example), to a body part as “seen” interacting with a virtual object. As another example, a head mounted virtual reality system may induce a touch sensation at a user's face or other head location that is visually correlated to the pushing of a button, or contact with a specific surface generated in the virtual space. After repeated experience of these correlated events, users may begin to experience the touch sensation as originating in the body part “contacting” the object or surface in a virtual space.

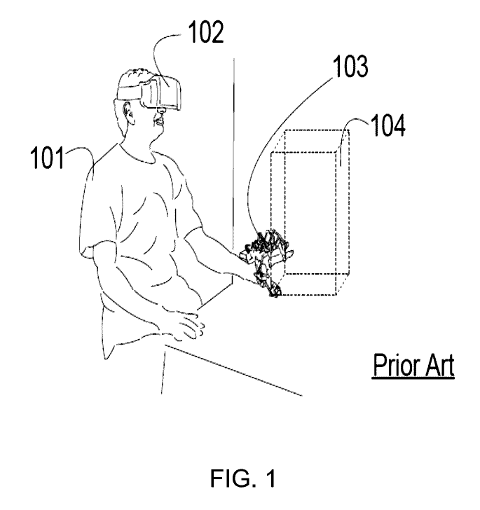

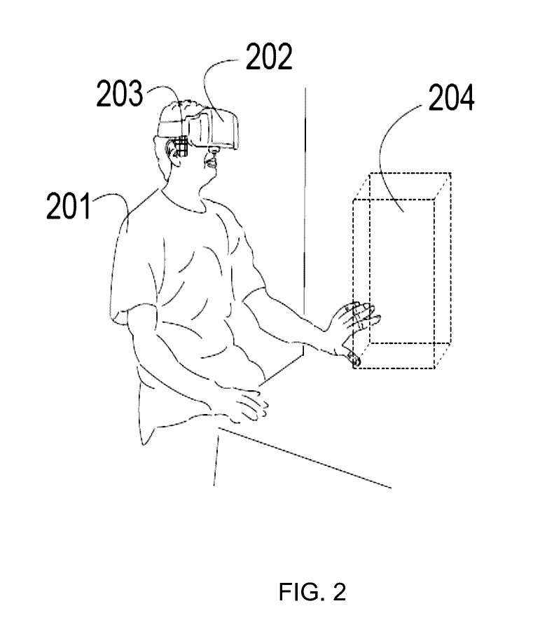

FIG. 2 shows a referred haptic interface in which the user 201 is, again, wearing a head mounted virtual reality display unit 202, but unlike the system shown in FIG. 1, the haptic actuators 203 generating the sense of touch in the user, are located on the head mounted display (HMD), itself, yet are still activated when the user extends a tracked hand or wand (real or virtual) or other tracked objects to interact with the virtual objects 204 generated in the user's visual field. After repeated operation, the user may come to perceive that the touch feedback is originating in his or her body part (such as hand) that appears to be in contact with the virtual objects when said touch feedback is actuated.

The haptic actuators 203 may comprise different numbers and arrangements of actuators depending on how many different stimulations/sensations are required to form an association with a specific body part. The haptic actuators 203 may be a set of spaced apart actuators such that associations may be made in the user's brain when specific actuators are active. Moreover, an individual actuator may have a range of output settings (e.g., frequency, duty cycle, amplitude) such that specific actuation patterns may be generated in an individual actuator or in set of actuators.

The haptic actuators 203 may be implemented in different ways. Touch actuators may make use of vibration, electric stimulation, acoustic stimulation, hot or cold spots, puffs of air pressure, mechanical means pressing on the skin or hair, etc. For example, in a game in which there is a penalty for touching some “electrified” objects, a small electric shock may be delivered when the virtual object is touched. In another embodiment, the HMD may tighten its band around the user's head as the user applies pressure with a virtual tool upon a virtual work piece. Electro-mechanical means such as linear motors or shape memory or electroactive polymer actuators may be used to move a contacting means or stylus along a path on the user, corresponding to some virtual movement or amount of force, etc. in the virtual world. Miniature vibrating motors with unbalanced rotors may be used to provide touch sensation or shake the visual display according to software generated events. In some embodiments the proximity of the HMD to specific areas of the user's brain may allow the use of transcranial magnetic stimulation or other electromagnetic or acoustic energy to generate direct brain stimulation. It will also be understood that combinations or sub-combination of different actuator types may be employed. Additionally, the haptic actuators may be employed as units that include a control processor, memory, communication interface, and any other required electronics to support the operation of the haptic actuators.

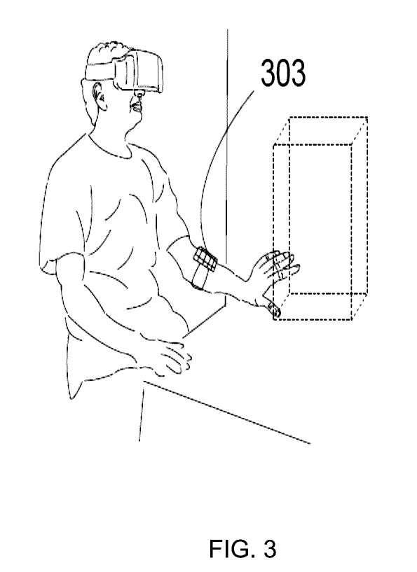

FIG. 3 shows a remote referred haptic actuation unit 303 in which the actuators have been moved to a module located on the user's body (other than the head). As an illustrative example, this may be attached to one or both arms. In one embodiment example, the haptic actuation unit 303 provides haptic feedback for the position of the user's hand relative to virtual objects. However, more generally, the haptic actuation 303 could be used to provide haptic feedback for another portion of the user's body.

In one embodiment, the HMD communicates the actuation control signals to the haptic actuation unit 303 by direct wire (not shown) or RF link or near field or skin conductance means, etc. In one embodiment, the sensations produced by the remote haptic actuation unit 303 are generated in response to interactions between virtual objects or surfaces and body locations that are not necessarily at the same position on the body as that remote unit.

Whereas the remote haptic actuation unit 303 of FIG. 3 is shown attached to the arm, those of ordinary skill in the art will understand that simulation could be moved to other areas such as placed inside shoes in which, for example, stimulation of the tips of toes may be mapped by training and association to corresponding fingers of the same side of the body. Other examples, including placing the haptic actuation unit 303 on the waist, the back, ankles, wrists etc. Moreover, it will be understood that a plurality of haptic actuation units 303 could be placed on different body parts (e.g., both wrists, both ankles, etc.).

In one embodiment, the haptic actuators provide stimulation in or around the human ear. The human ear provides a sensitive location for haptic stimulation that can be then referred to seem to be originating in other parts of the body. In one embodiment of the current invention, points on the outer ear or inside the ear canal may be stimulated by haptic actuators and, through training, be neurologically mapped to other parts of the body.

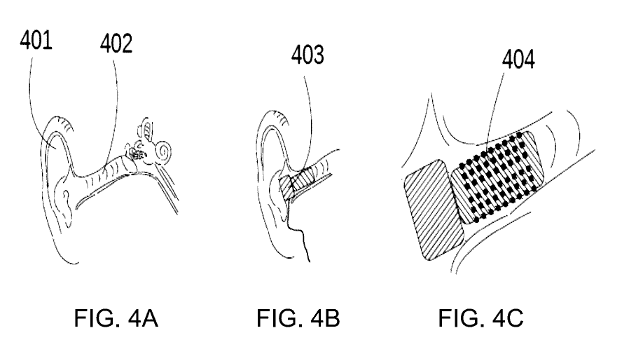

FIG. 4a show a diagram of an outer ear 401 and ear canal 402. It is common to build a class of ear phones as “earbuds” which have a portion that extends from the outer ear into the ear canal where a snug fit can be achieved. Such an arrangement is shown in FIG. 4b where earbud 403 has a cylindrical component that extends into the ear canal. FIG. 4c shows a haptic stimulator added to that cylindrical component with excitation points 404 placed along and around the surface so as to stimulate the nerves in the surrounding dermal tissue. The excitation points may be directly electrical or electromechanical actuators or thermal actuators or other means to stimulate the contacted nerves. As it is common to supply audio ear phones with HMD devices, these earbud stimulators may be implemented as audio devices with internal circuits that identify out of band digital or analog signals in the audio feed to power and/or activate specific stimulation points.

Examples of training will now be described. The generations of a referred haptic response depends on forming an association in the user's brain between the location of the physical stimulus and the referred location. Training is likely necessary to establish this association. In principal it might be possible, in some cases, to provide subliminal training. For example, suppose that a haptic actuation unit 303 is located on a user's arm. During the play of a game, the unit may be activated when a user's hand interacts with a virtual object. In this way, during the play of a game a user is exposed to haptic stimulation in one part of their body and experiences interactions with virtual objects that subliminally form associations to create the referred haptic response. Additionally, the level of haptic stimulation from the haptic actuators could be gradually increased during game play to gradually train the user.

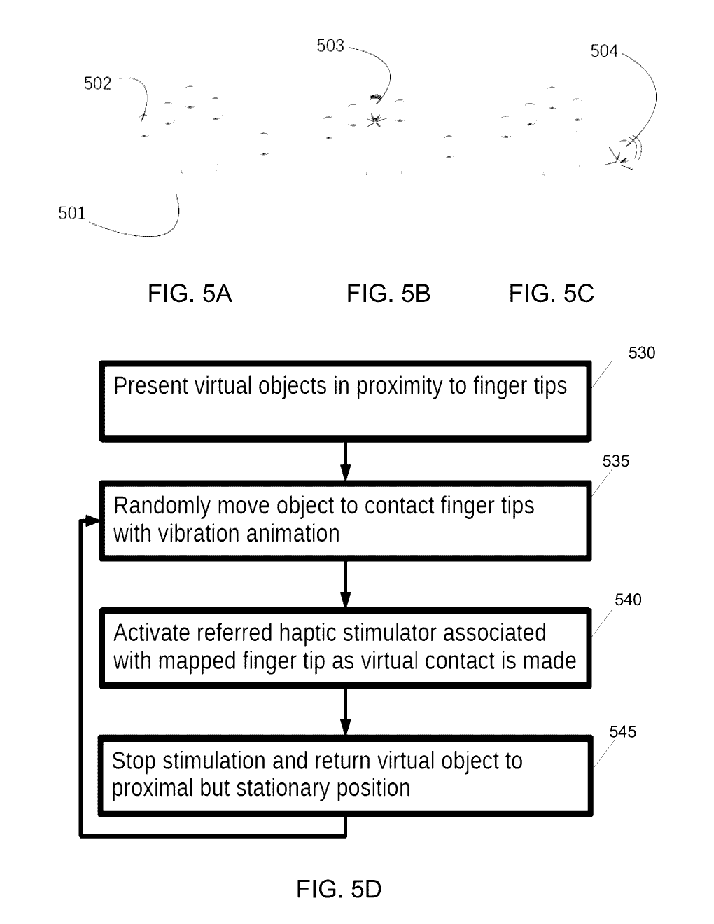

Although it is possible for the training to happen subliminally during game play, it is also possible to provide direct training activities. An example of a simple initial training method is shown in FIG. 5d, which illustrates a technique to form an association between haptic stimulation (originating at a portion of the user's body other than the fingers of the hand) and a virtual object presented in proximity to the user's fingers. FIGS. 5a, 5b, and 5c illustrate a user's hand 501. In FIG. 5a, virtual objects 502 are presented proximate a user's fingertips. In FIG. 5b, one of the virtual objects 503 is brought into contact with the user's middle finger and a haptic stimulation is performed at a location other than the user's fingers. In FIG. 5c, an object 5c is brought into contact with the user's thumb and a haptic stimulation is performed at a location other than the user's fingers.

FIG. 5d is a flowchart of a method in accordance with an embodiment. In this method the user is presented 530 with five virtual objects, such as balls, corresponding to each of five fingers on a hand to be trained. If the user is training in augmented reality, the system tracks the position of the user's hand through means such as computer vision or applied tracking markers; if the user is training in virtual reality, the system must also generate a representation of the user's hand and its position to be presented visually to the user.

The training proceeds by programmatically choosing a virtual object at random and moving 535 that object so that the user “sees” it touch an associated fingertip while the system activates the referred haptic stimulation 540 that is to be mentally mapped to that fingertip. The stimulation is stopped 545 and the virtual object is returned to a proximal but stationary position. This operation may be performed at least once. However, more generally it may be repeated many times for a session. Each hand, right and left, may be trained in subsequent sessions. Additionally, the training may be performed with different positions, such as both palm up and palm down.

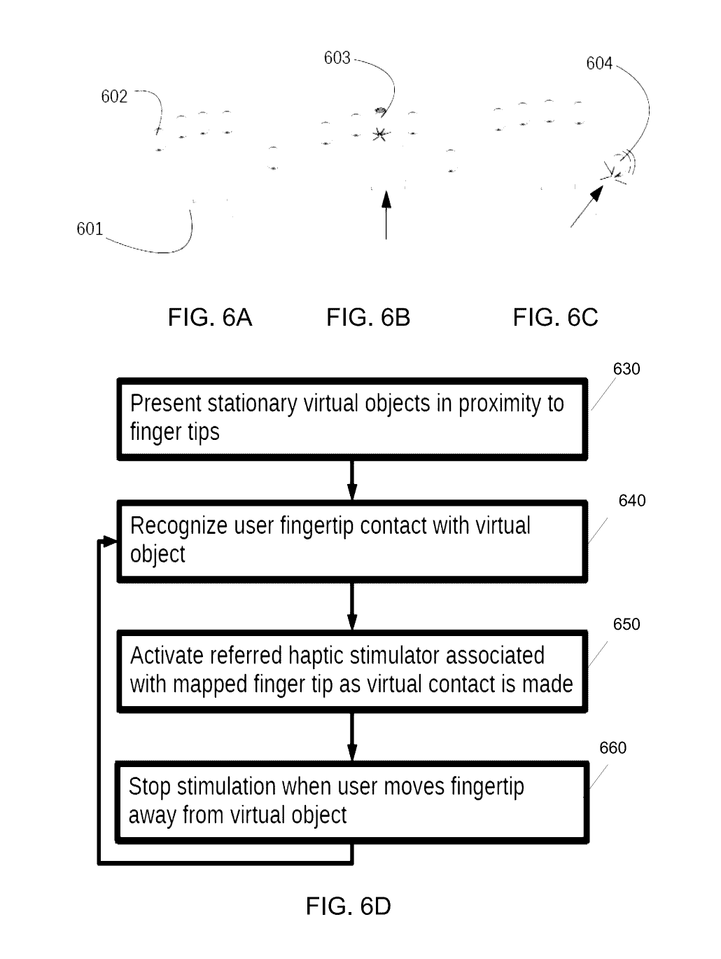

FIGS. 6A. 6B, 6C, and 6D show a method in which virtual objects are seen as stationary and the user moves his or her fingers in “contact” with these virtual objects. In one embodiment the method the virtual objects are seen as stationary and the user moves his or her fingers to “contact” these objects. FIG. 6A illustrates a set of stationary virtual balls, such as ball 602 in proximity to a user's hand 601. In FIG. 6B, the user has moved his or her middle finger to be in contact with the ball 603 and in FIG. 6C the user has moved his or her thumb to be in contact with ball 604.

FIG. 6D illustrates an exemplary method in accordance with an embodiment. The system monitors the position of the user fingertips with regard to the virtual positions of the objects so as to provide the mapped referred stimulus (again, not shown) when contact is made. The system presents 630 stationary virtual objects in proximity to the user's fingertips. The system recognizes 640 a user's fingertip contact with a virtual object. The system activates 650 a referred haptic stimulator associated with a mapped finger as virtual contact is made. The system stops 660 stimulation when a user moves the fingertip away from the virtual object. The user is encouraged to repeat this movement often, and may make contact with virtual objects in combination. Real objects (with touch sensors) may be substituted for the virtual objects in further training to give the user the real feeling of touching together with the referred haptic stimulation.

It will be understood that the training may be perform in a sequence. For example, in one embodiment the training of FIG. 5 is performed before the training of FIG. 6.

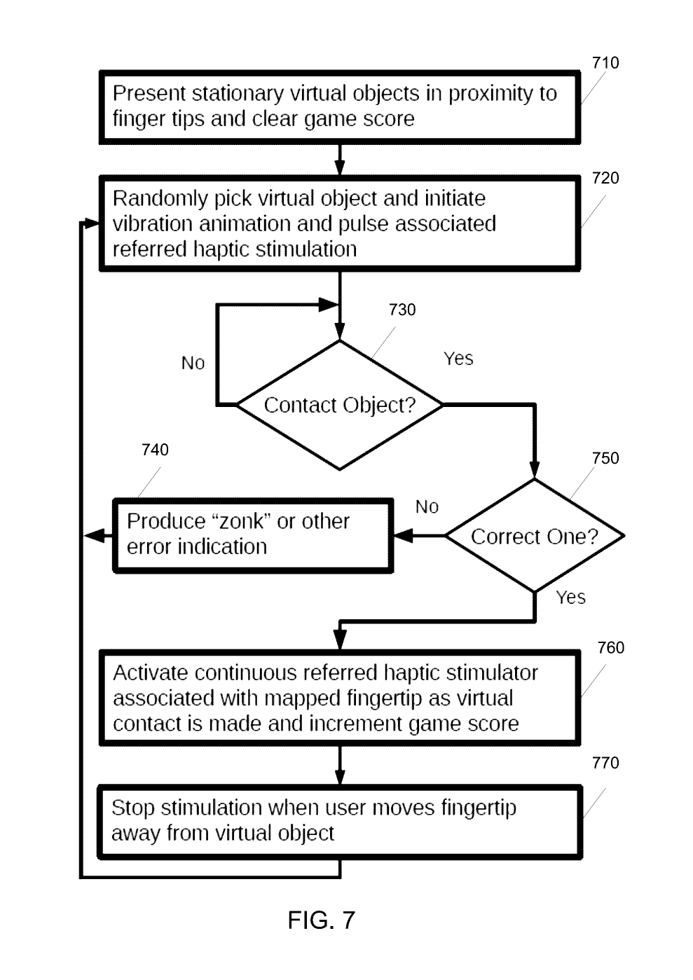

Training may be organized as a game, itself. FIG. 7 illustrates an example of a game in accordance with an embodiment. Here, the user has had initial training and must guess which referred haptic stimulation sensation is associated with which fingertip. Points are awarded for “correct” responses so as to reinforce the association, while “zonk” indications discourage errors. The system presents 710 stationary virtual objects in proximity to finger tips and clears a game score. A random selection is made of a virtual object 720 and an initiation is made of a vibration animation and the associated referred haptic stimulation is pulsed. In decision block 730, a determination is made whether contact has occurred with a virtual object. If it has, then a decision is made 750 whether the user has made the correct response. If not, an error indication is generated (e.g., a “zonk”). However, if a correct choice is made, a continuous referred haptic stimulator is activated 760 associated with the mapped fingertip as virtual contact is made and a game score is incremented. The stimulation is stopped 770 when a user moves his or her fingertip away from the virtual object.

It will be understood that FIG. 7 merely illustrates one example of a training game and other training games are within the scope of the present invention.

The training shown in FIGS. 5-7 were based on an all-or-nothing presence of referred haptic stimulation. However, in most environments it is anticipated that the system will be able to provide a range of stimulation intensity that corresponds to interactions between users and virtual objects of a range of values. For example, a virtual environment may include deformable virtual objects, such as a virtual rubber ball.

Training methods for this kind of interaction can be designed along the lines shown above, but with an added means of measuring and providing feedback on the degree of interaction.

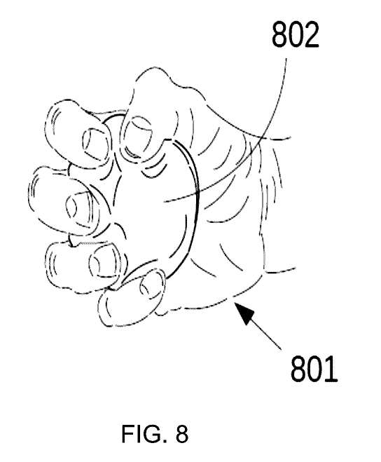

In one embodiment, variable finger force training is provided. An example is shown in FIG. 8 where the user is asked to reach a hand 801 behind and “grip” a virtual object 802 and apply force with fingertips. In this arrangement the system measures the position of the fingertips by means such as described in previous training, but then uses the position information to render deformations to the virtual object for the visual presentation, and to modulate the referred haptic simulation (not shown) so that the user gets a referred feeling of greater touch as the deformation increases. As in the previous case, it is also possible to substitute a real object to be gripped, given that such an object has sensors to detect the degree of pressure or deformation for input to the referred haptic stimulator.

While FIG. 8, illustrates variable force training, it will be understood that it may be generalized and applied to a variety of virtual objects. Other examples include a virtual object with a variable resistance, such as interacting with a thick virtual fog (light resistance), to a liquid (more resistance).

### Operation and Training Methods

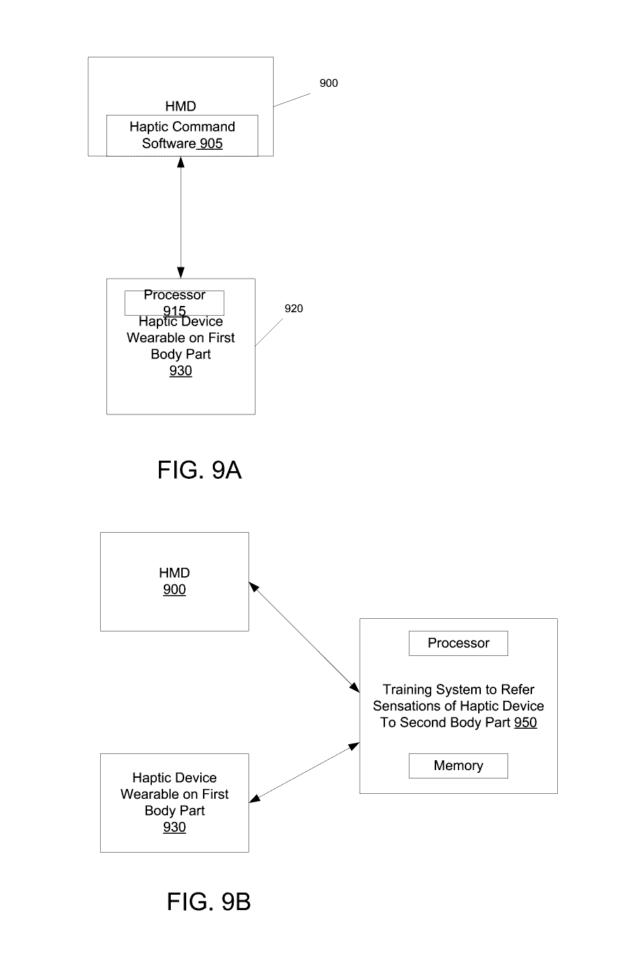

FIGS. 9A and 9B illustrate general aspects of training and use. As illustrated in FIG. 9A, during normal use, the HMD issues haptic feedback commands that are coordinated with the virtual images displayed by the HMD. The HMD may be an AR or VR HMD and operate in accordance with general principles of AR or VR. The haptic feedback commands are received by a haptic device that is wearable on a portion of the body (first body part) different from the location in the body in which there is referred haptic feedback. The haptic device 930 may include a processor 915, memory, and haptic actuators. In one implementation, the HMD 900 issues general haptic feedback commands that are interpreted by the haptic device 920. However, it is also possible that the HMD 900 is designed to know that the haptic device generated a referred haptic feedback. It is merely an implementation detail as to where the system, as a whole, performs control functions. Moreover, as previously described the haptic device 920 may communicate with the HMD using any suitable wired or wireless interface. In some embodiments the haptic device 920 may also be integrated into the HMD or otherwise attached to the user's head.

The training system may, in theory, be provided with the HMD or be in a computing device (not shown in FIG. 9A) that provides images to the HMD. However, it is also possible that the training system is a separate system with its own processor and memory. Moreover, some aspects of the training system may be implemented in a server-based system.

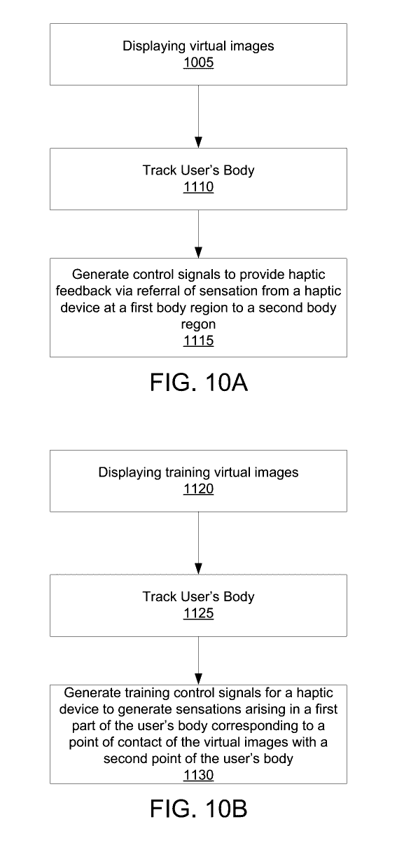

FIG. 10A illustrates a general method of operating a HMD in accordance with an embodiment. The HMD displays 1005 virtual images. The user's body is tracked 1110. Control signals are generated 1115 to provide haptic feedback via referral of sensation from a first body region to a second body region.

FIG. 10B illustrates a general training method in accordance with an embodiment. Virtual training images are displayed 1120. The user's body is tracked 1125. Training control signals are generated 1130 for a haptic device to generate sensations arising in a first region of a user's body corresponding to a point of contact of virtual images with a second body region of the user's body.

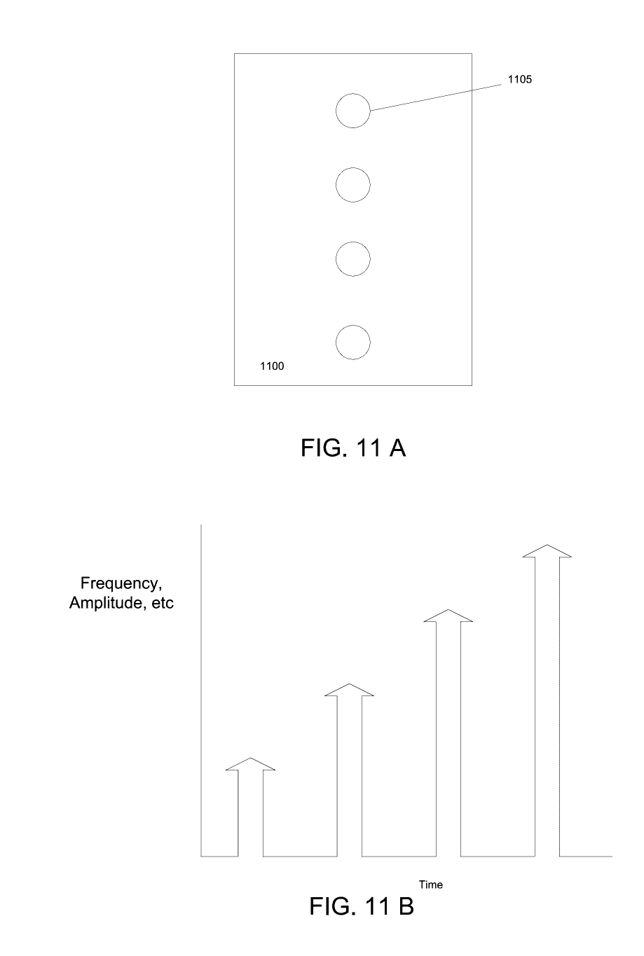

FIG. 11A illustrates an example of a haptic device in accordance with an embodiment. An individual haptic device 1100 may include one or more haptic activators/stimulators 1105. Moreover, in some embodiments, such as that illustrated in FIG. 11B, a frequency, amplitude, duty cycle or other stimulation attribute may be varied in an individual haptic activator/stimulator. By selection of the number, arrangements, and operating parameters of the haptic activators/stimulators, a variety of stimulation patterns may be generated from a single haptic device to permit referral to a range of body positions such as different finger positions or sensations.

### AR and VR Applications for Holding Fantasy Game Pieces

As previously discussed, embodiments of the present invention may be applied to both AR and VR environments. Additionally, embodiments of the present invention may be applied to AR environments in which there are additional real game elements.

While examples have been described in which a user touches a virtual object with their hand, it will also be understand that in various types of AR and VR games that users may “hold” or “grasp” virtual objects, such as virtual swords, magic wands, etc. The referred haptic feedback may thus also be used to refer to sensations associated with AR and VR fantasy elements grasped by a user's hand.

### Nonhuman Virtual Body Applications

Whereas embodiments of the invention have been described in terms of matching touch to vision, those skilled in the art will understand that the referred touch may be matched to auditory, proprioception, or other senses. Those familiar with virtual reality immersion games will understand that avatars created for users may have anatomical parts that do not correspond to human form (tails, extra arms etc.) that, nonetheless, may be trained and mapped to referred haptic simulation. This expansion of the internal “body image” in the mind greatly enhances the immersive experience of this category of game play.

### Personalization of Haptic Stimulation

It will also be understood that in some embodiments aspects of the haptic stimulation may be customized (“tuned”) for an individual user. For example, individual human beings have a different degree of skin sensitivity due to the structure of the skin and surrounding tissues affecting skin sensitivity such as the skin thickness, the thicknesses of underlying subcutaneous fat and muscle, etc. Additionally, there may also be individual neurological differences due to sports training or other influences. For example, some martial artists learn to “block out” feelings of pain in their arms.

An individual haptic actuator may have a variable rate of vibration, duty cycle, and intensity. In one embodiment, the response is customizable for an individual user.

Thus, in some embodiments a haptic actuator situated on an arm may have a tunable degree of stimulation. Also, over the course of training a user may become more sensitive to stimulation, which might permit a reduction in the degree of stimulation required. Thus, it will be understood that while the training phase may have the same stimulation as ordinary game play, more generally the stimulation may be adjusted during a training phase based on an individual user's physiology/neurology and any training response affecting the user's sensitivity to haptic stimulation.

In one embodiment, personalization data is collected and may be stored either in a HMD or with a haptic actuator, to support personalization.

In one embodiment, a user interface, such as a dial, could be provided in the real world or as a virtual object to provide a user with personalization options.

While customization may be performed in a training phase, it will also be understood that options may be provide for a user to customize response during the play of a test game, test application, regular AR/VR game play, or regular AR/VR application.

It will also be understood that the customization may be performed based on what types of haptic actuators the user selects, the places in the body that they decide to use them, and to what extent the user desires haptic feedback. For example, some users may desire only limited haptic feedback whereas other user may desire more extensive haptic feedback.

### Customization of Training/Use Based on Body Part

While examples of training have been provided, it will be understood that variations are contemplated. For example, in theory different modalities may be used to train different parts of the body. For example, through injury or atrophy individual users may have different physical and neurological responses for one hand or the other. Additionally, most people generally have a preferred side (e.g., right handed or left handed). Thus, in theory the training and/or referred haptic stimulation could be selected to be different for each hand to account for individual user differences and preferences.

### Referred Haptic Stimulation for Feelings of Size, Density, or Mass

It will also be understood that the customization may also be performed for other reasons, such as using referred haptic feedback to provide “feelings” of size or density. For example, a rate of vibration may be varied during training to form an association with the size or density of a virtual object. Human beings have a natural feeling that tiny things vibrate more quickly than larger things. Similarly, human beings have a natural feeling that there is a difference between low density objects (e.g., Styrofoam) and high density objects (e.g., a gold bar). Thus, in one embodiment, customization and training is performed to support, for example, developing feelings of interacting differently with a small virtual object (e.g., a virtual mouse) or a large virtual object (e.g., a virtual elephant). Alternatively, the customization and training may be performed to support interacting differently with objects based on their density.

### Examples of Commercial Applications

The capability to provide gloveless haptic feedback for the interactions of a human hand with virtual objects has many potential applications outside of game play. For example, in virtual sculpting tactical feedback helps an artist to shape the virtual materials they see. Conventionally, haptic gloves would be required, but these can be uncomfortable and restrictive of fine movement of the hands. Thus, the application of gloveless haptic feedback, based on referral, in accordance with embodiments of the present invention permits a user to have the benefits of haptic feedback for the interaction of their hands with virtual objects but without the disadvantages of conventional haptic feedback gloves. Similarly, there are applications in manufacturing in which there are potential advantages in cost or comfort in providing haptic feedback by referral. For example, in some manufacturing application haptic feedback may be used to provide feedback as to where parts are in space. Similarly, there are potential applications in medical training to train for feeling in the body.

### Other Game Applications

It will also be understood that in one embodiment the haptic training is performed to form a mental association with specific game sensations.

For example, subtle feelings, like feelings of dread, could be trained by forming an association between a “weird” feeling in one part of the body and music or images evoking a sense of dread. As another example, a “cold” feeling could be generated in a part of a body as subtle feeling that is associated with a “zombie” or other monster. In theory, this could be done directly (e.g., via a thermoelectric cooler as the haptic actuator). However, more generally some forms of vibration/stimulation generate nervous effects similar to a cold feeling. Through training a “cold touch” feeling may be generated as a special game feature. In analogous fashion, a “hot” feeling could be referred to a different game feeling, and so on.

As another example, in a martial arts game, the virtual objects presented during training could train the user to associate a sensation, such as that generated from a haptic actuator on an arm, with feelings associated with virtual objects in the game play. For example, an association could be made the sensation of being pierced by a knife.

One of ordinary skill in the art would understand that this technique of training and using referred haptic feedback may be customized for individual virtual games or other forms of virtual entertainment.

### Proprioception Training for Virtual Reality

As another application for game play, a training phase could include generating an association between a haptic stimulation on one part of the body (e.g., the arm) and proximity to a virtual or physical room boundary. One problem in virtual reality game play is that user's often begin to wander towards the walls. In one embodiment, training is performed so that a haptic actuator generates a sensation as a user approaches a wall. Through training, this can be referred to a general proprioception of where the user's body is in relation to walls. This type of referred proprioception does not have to be perfect to improve the user experience in many virtual games. It can also be performed in different ways, such as by tracking the user's movement and by activating a haptic actuation unit as the user approaches a room boundary or obstacle. A training phase may also be included to train the user to develop referred proprioception.

### Use with Conventional Haptic Feedback Devices

It will be understood that embodiments of the present invention may be used in combination with other conventional haptic feedback devices. As an example, during a training phase conventional haptic feedback gloves may be used initially and then the training perform to achieve a “transference” of skills to a gloveless approach based on referred haptic feedback.

### Other Techniques to Provide Haptic Stimulation

It will be understood that embodiments of the present invention may utilize any form of haptic stimulation that can be referred from one body location to another. Without being bound by theory, it is believed that training may permit even very subtle sensations to be used. As one example, some sound frequencies are so low that they are felt, not heard. Moreover, these low frequency sound waves are capable of traveling through the body. Thus, low frequency sound generators may also be employed as haptic stimulators. Cold and heat may also be employed, such as heat/cold actuators in earbuds.

As the human brain is highly trainable to become more sensitive and aware of subtle sensations, it will thus be understood that a variety of “weak” haptic stimulation types may be utilized through training. The length of training and type of training may also be customized for the specific type of haptic stimulation.

### Partial Referral of Haptic Stimulation

It will be understood that embodiments of the present invention may utilize partial haptic referral of sensation. For example, if the haptic actuators are positioned on the arm, the training may result in the user receiving haptic feedback for their fingers. There may be a complete referral of sensations through training. However, it will be understood that some residual sensation may still be located at the original site of the haptic stimulation. For example, if the haptic actuators are located on the arms the user might be able to still experience some sensation there if the user focused on that sensation. However, in the case of game play, the user's attention is typically intensely focused on game play and there will be a tendency for the human brain to ignore sensations not related to the game play. Thus, it will be understood that the referral of haptic stimulation from one point to another of the body may occur with different degrees of residual sensation in the original site of the haptic stimulation. From the perspective of playing an AR or VR game, the intense focus of users on game play may permit considerable residual feeling in the original site of haptic stimulation to remain but be blocked out by the fixation of the user on game play. Similarly, in some work applications users may be so absorbed in a work task performed using AR or VR that they block out residual feelings at the original site of the haptic stimulation. That is, another aspect of haptic referral is that during normal use of a game or work task there will be a tendency for the user to ignore residual feelings at the site of the haptic stimulation.

### Other Implementations

In one embodiment the haptic actuators are clipped onto the backs of gloves or straps and refer to events supposed to happen on the fingertips. Thus, the user gets many of the benefits of haptic gloves without the discomfort and loss of mobility associated with conventional haptic gloves that require actuators in the fingertips. As one example, “fingerless” gloves could be used and the haptic actuators placed on the backs of the gloves and the haptic sensation referred to the fingertips. As another example, a wrist strap or wrist bracelet could house the haptic actuators with the referred feelings being felt in the fingertips of the user. In one embodiment, at least two haptic actuators are placed around the circumference of a user's wrist. More generally, a set of haptic actuators could be placed around the entire wrist. In this case, an individual haptic actuator may be selected at one time or two or more selected at one time to create different “patterns” of haptic stimulation around a user's wrist.

### INCORPORATION BY REFERENCE

The following U.S. patents and publications are each hereby incorporated by reference:
U.S. Pat. No. 3,780,225
U.S. Pat. No. 3,919,691
U.S. Pat. No. 5,769,640
U.S. Pat. No. 8,350,843
U.S. Pat. No. 8,378,797
U.S. Pat. No. 9,092,954
U.S. Pat. No. 9,098,141
U.S. Pat. No. 9,142,105
“Haptic technology simulates the sense of touch—via computer”. News-service. stanford.edu. (2003).
Lisa Zyga, “Touchable Hologram Becomes Reality (w/ Video)”. Physorg.com. (2009).
V. L. Petkova and H. H. Ehrsson, “When right feels left: referral of touch and ownership between the hands.” PLoS One. 2009 Sep. 9; 4(9):e6933. doi: 10.1371/journal.pone.0006933.
V. S. Ramachandran and Eric L. Altschuler, “The use of visual feedback, in particular mirror visual feedback, in restoring brain function”, Brain (2009): 132; pp. 1693-1710
Pomés Freixa, Ausiàs, and Mel Slater. “Drift and ownership toward a distant virtual body.” Frontiers in Human Neuroscience, 2013, vol. 7, num. 12 (2013).

It will be understood that exemplary methods of use and training techniques may also be embodied as computer code stored on non-transitory computer readable medium.

An illustrative embodiment has been described by way of example herein. Those skilled in the art will understand, however, that change and modifications may be made to this embodiment without departing from the true scope and spirit of the elements, products, and methods to which the embodiment is directed, which is defined by my claims.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or computing devices. In addition, those of ordinary skill in the art will recognize that devices such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. A gloveless system to provide haptic feedback for a human hand, comprising:
at least one haptic output device arranged to be worn on non-finger regions of a human body of a user and provide haptic stimulation via one or more haptic actuators;
at least one processor to receive commands from a head mounted display system and in response select the haptic stimulation to utilize referral of sensation to provide haptic feedback for at least the fingers of the user's hand.

2. The system of claim 1, wherein the haptic stimulation is selected from a set of haptic actuator options to provide haptic feedback for each finger of the human hand.

3. The system of claim 2, wherein the at least one haptic output device has a set of haptic stimulation points.

4. The system of claim 2, wherein the at least one haptic output device has a set of different activation attributes.

5. The system of claim 1, where the at least one haptic output device comprises an ear piece having a plurality of haptic activation points.

6. The system of claim 1, wherein the at least one haptic output device is integrated into the head mounted display.

7. The system of claim 1, further comprising a training system to coordinate at least one training sequence of virtual images to train a user to refer sensations from the at least one haptic output device to fingers of the human hand.

8. A system to provide proprioception and/or somatosensory experiences, comprising:
at least one haptic output device configured to be worn on a first region of a human body and provide a selectable haptic stimulation from at least one haptic actuator;
at least one processor to receive commands from a head mounted display system and in response select the haptic stimulation to utilize referral of sensation to provide haptic feedback for a second region of the human body.

9. The system of claim 8, further comprising:
a training system to coordinate a sequence of virtual images from the head mounted display and haptic output feedback from the at least one haptic output device to train a user to refer sensations.

10. The system of claim 9, wherein the training system includes at least one training protocol to present virtual objects proximate at least one body part of the user and activate a haptic output device to form an association between the at least one body part and haptic stimulation generated by the at least one haptic device.

11. The system of claim 9, wherein the at least one training protocol presents a virtual object proximate a finger of the user and activates the at least one haptic output device to form an association between the virtual object and the finger.

12. The system of claim 9, wherein the training system presents a stationary virtual object and the at least one haptic output device is activated when the user moves a body part proximate the virtual object.

13. The system of claim 12, wherein the at least one training protocol present a stationary virtual object and a haptic output device is activated when the user moves a finger proximate the virtual object.

14. The system of claim 9, wherein the training system comprises at least one training game.

15. A method of operating a head mounted display, comprising:
displaying virtual images; and
generating control signals, coordinated with the displaying of the virtual images, to utilize referral of sensation from a haptic device in a first region of a user's body to provide haptic feedback for a second region of the user's body.

16. The method of claim 15, wherein the second region is a hand region and the first region is a non-hand region.

17. The method of claim 15, further comprising tracking the user's body, detecting virtual contact of the virtual images with the user's body, and providing haptic feedback indicative of the contact.

18. The method of claim 15, further comprising providing a training phase to train the user to refer sensations from the first region to the second region.

19. The method of claim 18 wherein the training phase includes at least one training protocol to present virtual object proximate at least one body part of the user and activate a haptic output device to form an association between the at least one body part and activated haptic output device.

20. The method of claim 18, wherein the training phase presents a virtual object proximate a finger of the user and actives a haptic output device to form an association between the virtual object and the finger.

21. The method of claim 18, wherein the training phase presents a stationary virtual object and a haptic output device is activated when the user moves a body part proximate the virtual object.

22. The method of claim 18, wherein the training phase presents a stationary virtual object and a haptic output device is activated when the user moves a finger proximate the virtual object.

23. The method of claim 18, wherein the training phase comprises at least one training game.

24. A method of operating a head mounted display, comprising:
displaying virtual images; and
generating control signals, coordinated with the displaying of the virtual images, to utilize referral of sensation from a haptic device in a first region of a user's body to provide haptic feedback not specifically related to the first region of the user's body.
